(19) United States
(12) Patent Application Publication
(10) Pub. No.: US 2004/0200583 A1
(43) Pub. Date: Oct. 14, 2004

(54) Window blind assembly control crank gear

(75) Inventor: Ming Nien, Changhua Hsein (TW)

Correspondence Address: BROWDY AND NEIMARK, P.L.L.C., 624 NINTH STREET, NW, SUITE 300, WASHINGTON, DC, 20001-5303, US

(73) Assignee: Nien Made Enterprise Co., Ltd., Taichung (TW)

(21) Appl. No.: 10/448,129

(22) Filed: May 30, 2003

(30) Foreign Application Priority Data
Apr. 9, 2003 (TW) 92205680

(51) Int. Cl. E06B 9/38

(52) U.S. Cl. 160/177 R

(57) ABSTRACT

A window blind assembly control crank gear includes a top rod, an intermediate rod and a bottom rod pivoted to the intermediate rod. The top rod has a coupling block with a transverse pivot hole. The intermediate rod has a coupling lug including two upright sidewalls and two pivot holes respectively formed in the upright sidewalls and axially aligned. A fastener is passed through the pivot hole of the coupling block and the pivot holes of the coupling lug to pivotally secure the coupling block to the coupling lug between the upright sidewalls and to impart a pressure to the upright sidewalls against the coupling block for enabling the intermediate rod to be turned relative to the top rod and quickly positioned in an adjusted angular position.

### BACKGROUND OF THE INVENTION

1. Field of the Invention

The present invention relates generally to window blind assemblies and, more particularly, to a window blind assembly control crank gear. The invention relates also to a window blind assembly having such a control crank gear.

2. Description of the Related Art

A regular Venetian blind comprises a lifting control unit and a slat tilting control unit. The lifting control unit comprises lift cords extended to the outside for operation by the user. However, because the exposed portions of the lift cords may be hung on the body of a person accidentally, causing death. In order to eliminate this problem, a rotary driving bar is disclosed to match with a transmission mechanism instead of conventional lift cords. It is also well known to use a rotary driving rod for controlling the tilting angle of blind slats. In general, a rotary driving rod may be used in a window blind assembly to separately or concomitantly control the lifting of the blind and the tilting of the slats, thereby changing the light shading status of the window blind assembly.

There is known a folding collapsible crank design for use in a window blind assembly to control the light shading status of the blind slats. This design is seen in Swiss patent No. 689234. The folding collapsible crank disclosed in the Swiss patent No. 689234 is comprised of a top rod, an intermediate rod and a bottom rod. The top rod, the intermediate rod and the bottom rod are axially connected to one another. When in use, hold the top rod and the bottom rod with the hands and turn the connections to a particular angle, and then turn the bottom rod about the top rod to further control the light shading status of the blind. According to this design, the bottom end of the top rod and the top end of the bottom rod are shaped like a flat block, and the intermediate rod has two spring members provided in the top and bottom ends thereof and respectively stopped against the flat block-like bottom end of the top rod and the flat block-like top end of the bottom rod, for enabling the top rod and the bottom rod to be respectively set in the operative position perpendicular to the intermediate rod. This design is still not satisfactory in function. Because this folding collapsible crank can only be set in one particular position (angle) for operation, it does not fit different persons of different body heights. In general, this design is not orthopedically engineered.

### SUMMARY OF THE INVENTION

It is the main object of the present invention to provide a window blind assembly control crank gear, which is orthopedically engineered.

It is another object of the present invention to provide a window blind assembly control crank gear, which can be set in one of a series of operation positions to fit different persons.

It is still another object of the present invention to provide a window blind assembly control crank gear, which has fine adjustment means for adjusting the position retaining force.

To achieve these objects of the present invention, the window blind assembly control crank gear comprises a top rod having a bottom end terminating in a coupling block with a transverse pivot hole, an intermediate rod having a coupling lug at the top, the coupling lug having two upright sidewalls and two pivot holes respectively formed in the upright sidewalls and axially aligned, and a fastener passed through the pivot hole of the coupling block and the pivot holes of the coupling lug to pivotally secure the coupling block to the coupling lug between the upright sidewalls of the coupling lug and to impart a pressure to the upright sidewalls against the coupling block for enabling the intermediate rod to be turned relative to the top rod and quickly positioned in an adjusted angular position, and a bottom rod pivoted to a bottom end of the intermediate rod.

### BRIEF DESCRIPTION OF THE DRAWINGS

FIG. 1 is a perspective view of a window blind assembly equipped with a control crank gear according to a first preferred embodiment of the present invention.

FIG. 2 is a perspective view of a window blind assembly control crank gear according to the first preferred embodiment of the present invention.

FIG. 3 is an exploded view in an enlarged scale of a part of the window blind assembly control crank gear according to the first preferred embodiment of the present invention.

FIG. 4 illustrates the window blind assembly control crank gear of the first preferred embodiment of the present invention set in one operation position.

FIG. 5 is an exploded view of a part of a window blind assembly control crank gear according to a second preferred embodiment of the present invention.

### DETAILED DESCRIPTION OF THE INVENTION

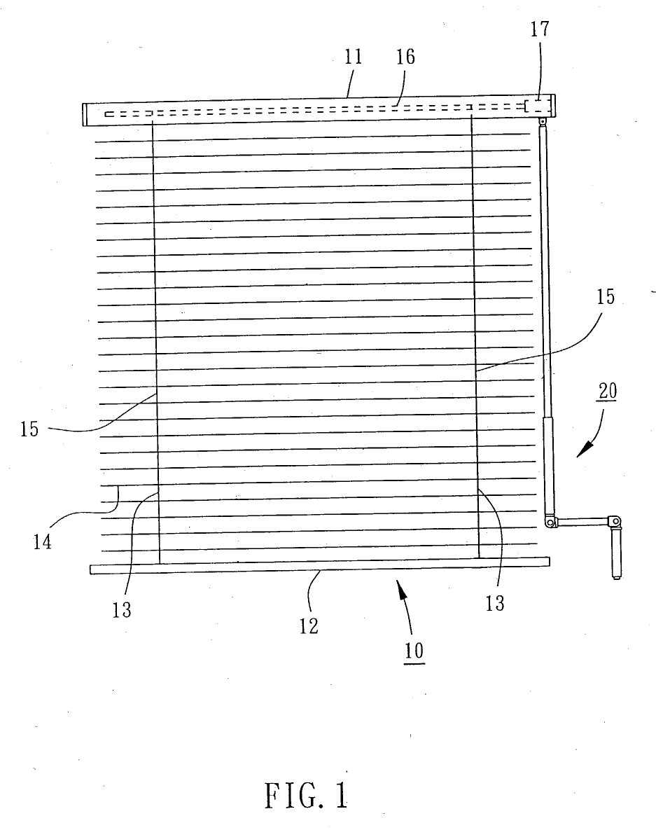

Referring to FIG. 1, a window blind assembly control crank gear 20 is for use in a window blind assembly 10 comprised of a headrail 11, a bottom rail 12, two ladder tapes 13 connected between the headrail 11 and the bottom rail 12, a set of slats 14 arranged in parallel between the headrail 11 and the bottom rail 12 and fastened to the ladder tapes 13, two lift cords 15 (the lift cords and the ladder tapes are overlapped in FIG. 1) each having one end affixed to the bottom rail 12 and the other end upwardly inserted through the slats 14 into the inside of the headrail 11, a shaft 16 mounted inside the headrail 11 and adapted to roll up the ladder tapes 13 and/or the lift cords 15, and a transmission mechanism 17 mounted in the headrail 11 and coupled to one end of the shaft 16. The control crank gear 20 is connected to the transmission mechanism 17 and vertically suspended at one lateral side of the window blind assembly 10 for turning by hand to drive the transmission mechanism 17 to rotate the shaft 16 clockwise or counter-clockwise, so as to further lift or lower the bottom rail 12 or tilt the slats 14.

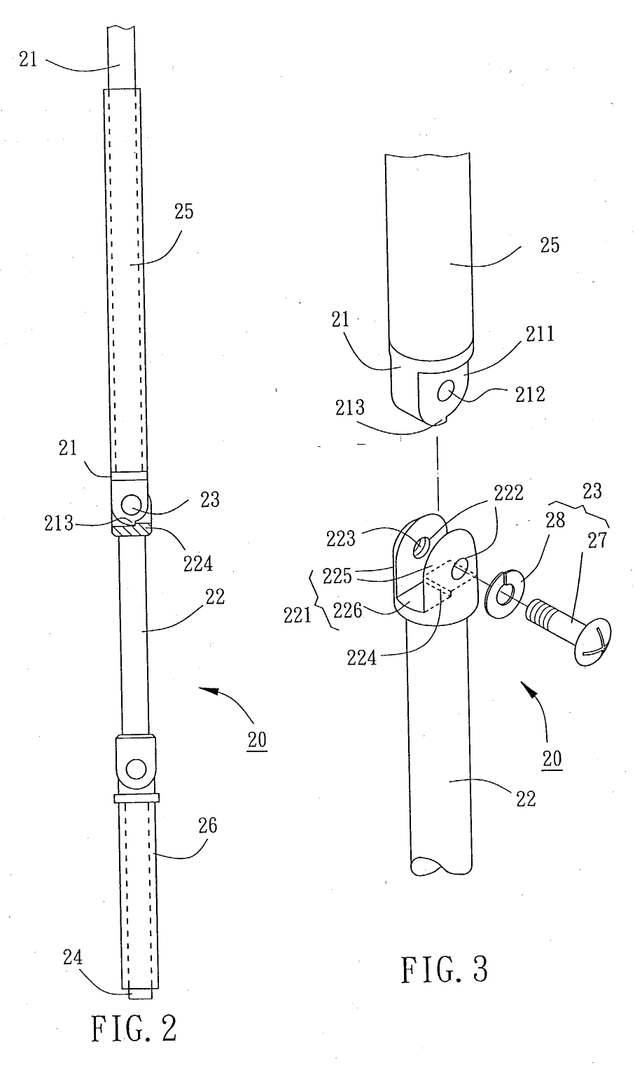

Referring to FIGS. 2˜4, the control crank gear 20 is comprised of a top rod 21, an intermediate rod 22, a fastener 23, a bottom rod 24, an upper sleeve 25, a lower sleeve 26.

The top rod 21 is a round rod member having a top end detachably connected (or affixed) to the transmission mechanism 17 of the window blind assembly 10, and a bottom end terminating in a flat coupling block 211, which has a pivot hole 212 extended through two opposite flat sidewalls thereof and a front protrusion 213 protruding from the smoothly arched front wall thereof.

The intermediate rod 22 is a round rod member having a top end terminating in a coupling lug 221 and a bottom end pivoted to the bottom rod 24. The coupling lug 221 comprises a flat base 226, two parallel upright sidewalls 225 bilaterally upwardly extended from the flat base 226 and spaced from each other at a space slightly smaller than the thickness of the flat coupling block 211 of the top rod 21, two pivot holes 222 respectively transversely extended through the upright sidewalls 225 and aligned in a line, an engagement portion, for example, an inner thread 223 formed in one pivot hole 222, and a stop block 224 protruded from the flat base 226 between the upright sidewalls 225 at one side. Because the pitch between the upright sidewalls 225 is slightly smaller than the thickness of the flat coupling block 211 of the top rod 21, the top rod 21 and the intermediate rod 22 are secured together by friction resistance when the flat coupling block 211 plugged into the coupling lug 221 in between the upright sidewalls 225. When the flat coupling block 211 plugged into the coupling lug 221 in between the upright sidewalls 225, the fastener 23 is installed in the pivot holes 212 and 222 to pivotally secure the top rod 21 and the intermediate rod 22 together. When connected together, the top rod 21 and the intermediate rod 22 can be set in a line where the front protrusion 213 is stopped at the stop block 224 to hold the top rod 21 and the intermediate rod 22 in the axially aligned position.

The fastener 23 is comprised of a screw bolt 27 and a holding down member, for example, a spring washer 28. The screw bolt 27 is inserted through one pivot hole 222 of the coupling lug 221 and the pivot hole 212 of the coupling block 211 and threaded into the inner thread 223 in the other pivot hole 222 of the coupling lug 221 to pivotally secure the top rod 21 and the intermediate rod 22 together. The spring washer 28 is clamped on the screw bolt 27 and stopped between the head of the screw bolt 27 and one upright sidewall 225 of the coupling lug 221 to hold down the screw bolt 27.

The bottom rod is a round rod member having a top end pivoted to the bottom end (free end) of the intermediate rod 22. The connecting structure between the bottom end of the top rod 21 and the top end of the intermediate rod 22 may be employed to the connection between the bottom end of the intermediate rod 22 and the top end of the bottom rod 24. However, simply pivoting the top end of the bottom rod 24 to the bottom end of the intermediate rod 22 achieves the desired functions of the present invention.

The upper sleeve 25 is a round tube sleeved onto the top rod 21. The lower sleeve 26 is a round tube sleeved onto the bottom rod 24. The upper and lower sleeves 25 and 26 are provided for holding by the user's hands, preventing direct friction between the hands and the top and bottom rods 21 and 24 during operation.

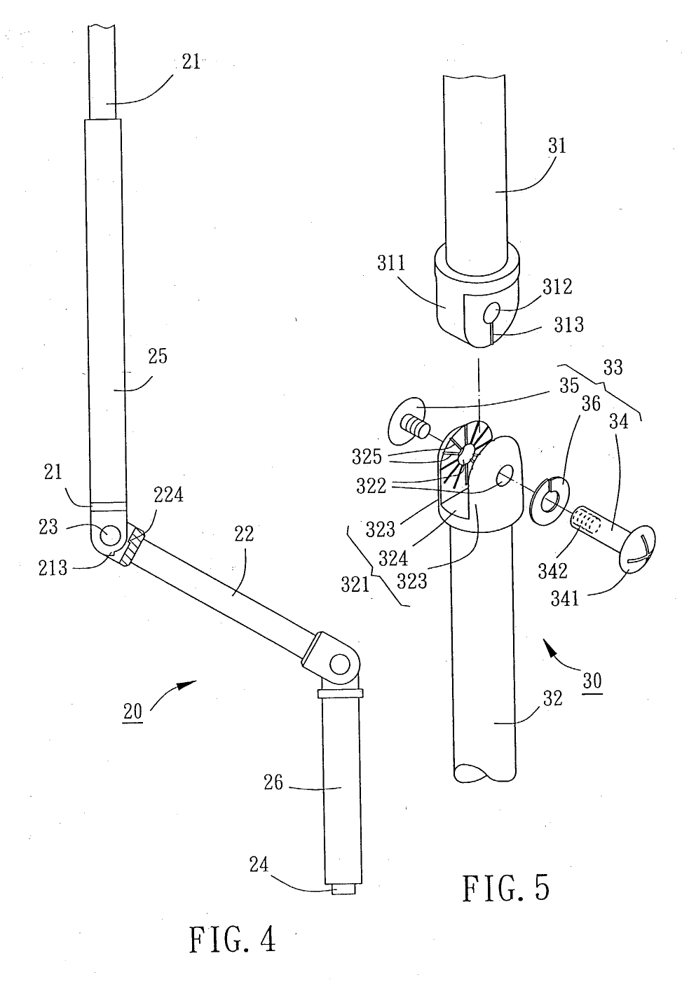

The operation of the control crank gear 20 is outlined hereinafter. Normally, the control crank gear 20 is set in a line as shown in FIG. 2. When operating the control crank gear 20, hold the upper sleeve 25 and the lower sleeve 26 with both hands, and then apply a force to the lower sleeve 26 relative to the upper sleeve 25 and the top rod 21 to change the angle of the intermediate rod 22 from vertical to a particular angle, for example, 120° relative to the top rod 21 and the bottom rod 24 (see FIG. 4), and then turn the lower sleeve 26 and the bottom rod 24 about the axis passing through the top rod 21 to drive the transmission mechanism 17 to rotate the shaft 16 (see also FIG. 1). After operation, apply a force to the upper sleeve 25 and the lower sleeve 26 in reversed directions, pulling the control crank gear 20 back to the straight condition.

This embodiment achieves the advantages as follows:

1. When the protrusion 213 of the coupling block 211 stopped at the stop block 224 of the coupling lug 221, the top rod 21 and the intermediate rod 22 are positively maintained in a line. Therefore, the user can easily return the control crank gear 20 to the straight status.

2. The friction between the coupling lugs 221 and the coupling block 21 and the clamping force of the spring washer 28 of the fastener 23 enables the intermediate rod 22 to be freely adjusted to any of a series of angular positions to fit different users and quickly and positively positioned in the adjusted angular position. Therefore, the control crank gear 20 is constantly maintained in the adjusted angular position during operation.

3. When the fastener 23 installed, the screw bolt 27 is meshed with the inner thread 223 in one pivot hole 222 of the coupling lug 221 to pivotally secure the top rod 21 to the intermediate rod 22. Further, the user can rotate the screw bolt 27 inwards or backwards in the inner thread 223 to adjust the friction resistance between the two upright sidewalls 225 of the coupling lug 221 and the coupling block 211.

FIG. 5 is an exploded view of a part of the second preferred embodiment of the window blind assembly control crank gear 30 of the present invention. According to this embodiment, the coupling block 311 of the top rod 31 has a pivot hole 312 extended through two opposite flat sidewalls thereof, and two elongated ribs 313 respectively formed in the two opposite flat sidewalls and longitudinally extended from the pivot hole 312 to the front smoothly arched front end. The coupling lug 321 of the intermediate rod 32 comprises a flat base 324, two parallel upright sidewalls 323 upwardly extended from the flat base 324 at two sides, two pivot holes 322 respectively formed in the upright sidewalls 323 and axially aligned, and two sets of radial grooves 325 respectively formed in the upright sidewalls 323 at an inner side and equiangularly spaced around the pivot holes 322. According to this embodiment, the number of each set of radial grooves 325 is 12, and the 12 radial grooves 325 are spaced from one another at 30° around the corresponding pivot hole 322. The fastener 33 is comprised of a pivot 34, a screw cap 35, and a spring washer 36. The pivot 34 has a head 341 at one end and thread means, i.e. a screw hole 342, at the other end. The pivot 34 is inserted through the pivot holes 322 of the coupling lug 321 and the pivot hole 312 of the coupling block 311 to pivotally secure the top rod 31 and the intermediate rod 32 together. The screw cap 35 is threaded into the screw hole 342 to secure the pivot 34 to the coupling lug 321. The spring washer 36 is clamped on the pivot 34 and stopped between the head 341 of the pivot 34 and one upright sidewall 323 of the coupling plug 321. When installed, the elongated ribs 313 are meshed with the radial grooves 325. Further, the pivot 34 and the screw cap 35 can be rotated relative to each other to adjust the friction resistance between the upright sidewalls 323 of the coupling lug 321 and the coupling block 311. According to this embodiment, the angular position of the intermediate rod 32 can be adjusted relative to the top rod 31 step by step, i.e., by shifting the elongated rib 313 from one radial groove 325 to another. Further, a screw bolt and a nut may be used instead of the pivot 34 and the screw cap 35, achieving the same effect.

What is claimed is:

1. A window blind assembly control crank gear comprising:
a top rod having a coupling block at a bottom end thereof and a transverse pivot hole extended through two opposite sidewalls of said coupling block;
an intermediate rod having a coupling lug at a top end thereof and a bottom end, said coupling lug having a base, two upright sidewalls upwardly extended from said base at two sides, and two pivot holes respectively formed in said upright sidewalls and axially aligned;
a fastener passed through the pivot hole of said coupling block and the pivot holes of said coupling lug to pivotally secure said coupling block to said coupling lug between said upright sidewalls of said coupling lug and to impart a pressure to said upright sidewalls against the two opposite sidewalls of said coupling block; and
a bottom rod pivoted to the bottom end of said intermediate rod at a top end thereof.

2. The window blind assembly control crank gear as claimed in claim 1, wherein said coupling lug of said intermediate rod further comprises an inner thread formed in one of the pivot holes thereof; said fastener comprises a screw bolt passed through the pivot hole of said coupling block and the pivot holes of said coupling lug and threaded into said inner thread.

3. The window blind assembly control crank gear as claimed in claim 2, wherein said fastener further comprises a spring washer clamped on said screw bolt and stopped between one end of said screw bolt and one of the upright sidewalls of said coupling lug.

4. The window blind assembly control crank gear as claimed in claim 1, wherein said fastener comprises a pivot member having a cylindrical body, a head at one end of said cylindrical body, and thread means at an opposite end of said cylindrical body, and a holding member meshed with the thread means of said pivot member.

5. The window blind assembly control crank gear as claimed in claim 4, wherein said fastener further comprises a spring member provided between the head of said pivot member and one of the upright sidewalls of said coupling block of said intermediate rod.

6. The window blind assembly control crank gear as claimed in claim 4, wherein said thread means of said pivot member is an inner thread, and said holding member is a screw member threaded into said inner thread of said pivot member.

7. The window blind assembly control crank gear as claimed in claim 4, wherein said thread means of said pivot member is an outer thread, and said holding member is a screw nut threaded onto said outer thread of said pivot member.

8. The window blind assembly control crank gear as claimed in claim 1, wherein said upright sidewalls of said coupling lug are spaced by a gap slightly smaller than the width between the opposite sidewalls of said coupling block so that said coupling block is fitly secured to said coupling lug when plugged in between said upright sidewalls of said coupling lug.

9. The window blind assembly control crank gear as claimed in claim 1, wherein said coupling block of said top rod comprises at least one elongated rib formed in at lease one of the two opposite sidewalls thereof and longitudinally extended from the pivot hole of said coupling block; said coupling lug comprises a plurality of radial grooves respectively formed in at least one of said upright sidewalls at an inner side and equiangularly spaced around the pivot hole of said respective upright sidewall for engagement with the at least one elongated rib of said coupling block.

10. The window blind assembly control crank gear as claimed in claim 1, wherein said coupling block of said top rod comprises a protrusion protruded from a smoothly arched front end thereof; said coupling lug of said intermediate rod further comprises a stop block protruded from said base and adapted to engage the protrusion of said coupling block when said top rod and said intermediate rod axially aligned.

11. The window blind assembly control crank gear as claimed in claim 1, further comprising a lower sleeve sleeved onto said bottom rod and fixedly secured thereto.

12. The window blind assembly control crank gear as claimed in claim 11, further comprising an upper sleeve sleeved onto said top rod and fixedly secured thereto.

13. A window blind assembly comprising:
a headrail;
a plurality of blind slats suspended from said headrail;
a control system for regulating light shading status of the blind slats;
a top rod having a top end connected to said control system, a coupling block at a bottom end thereof and a transverse pivot hole extended through two opposite sidewalls of said coupling block;
an intermediate rod having a coupling lug at a top end- thereof and a bottom end, said coupling lug having a base, two upright sidewalls upwardly extended from said base at two sides, and two pivot holes respectively formed in said upright sidewalls and axially aligned;
a fastener passed through the pivot hole of said coupling block and the pivot holes of said coupling lug to pivotally secure said coupling block to said coupling lug between said upright sidewalls of said coupling lug and to impart a pressure to said upright sidewalls against the two opposite sidewalls of said coupling block; and
a bottom rod pivoted to the bottom end of said intermediate rod at a top end thereof.
